(19) United States
(12) Patent Application Publication
(10) Pub. No.: US 2006/0170182 A1
(43) Pub. Date: Aug. 3, 2006

(54) Manual wheelchair drive system

(76) Inventor: Mark Kevin Mittelstaedt, Tucson, AZ (US)

Correspondence Address: MARK MITTELSTAEDT, 5941 E. FORT CRITTENDON, TUCSON, AZ, 85750, US

(21) Appl. No.: 11/049,312

(22) Filed: Feb. 1, 2005

(51) Int. Cl. B62M 1/14

(52) U.S. Cl. 280/244

(57) ABSTRACT

This wheelchair drive system consists of one-way bearings mounted on drive axles coaxial with the drive wheels of a wheelchair, drive levers attached to these axles, and frictional braking surfaces on the side of the drive levers proximal to the wheelchair drive wheels. The drive levers allow the user to push against a handle, maintaining a continuous grip. By pushing on the drive levers, the wheelchair is propelled forward. The one-way bearings allow the levers to “freewheel” back to a position where they can be pushed forward again, thereby allowing the user to move the chair forward without having to sequentially grab, push, release, reacquire then push the drive rims on many wheelchairs. The braking surfaces on the inside of the levers are actuated by pressing the levers against the wheels, slowing the chair with both brakes, or using one brake to turn.

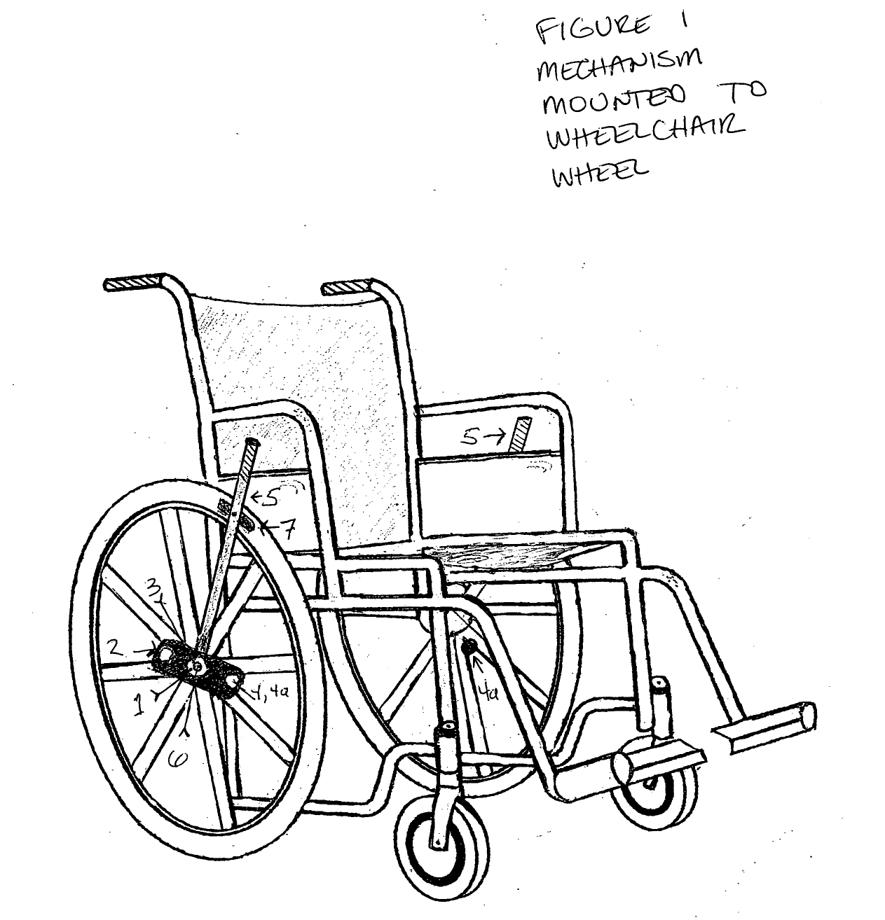

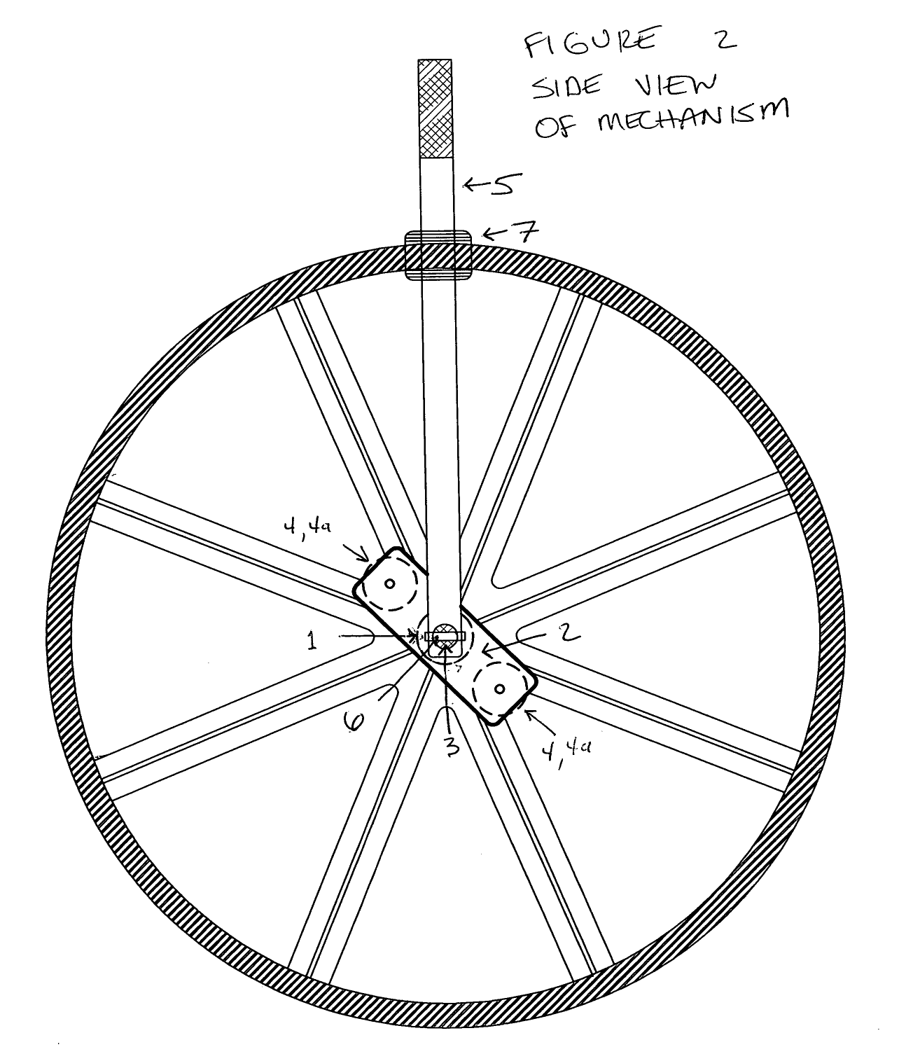

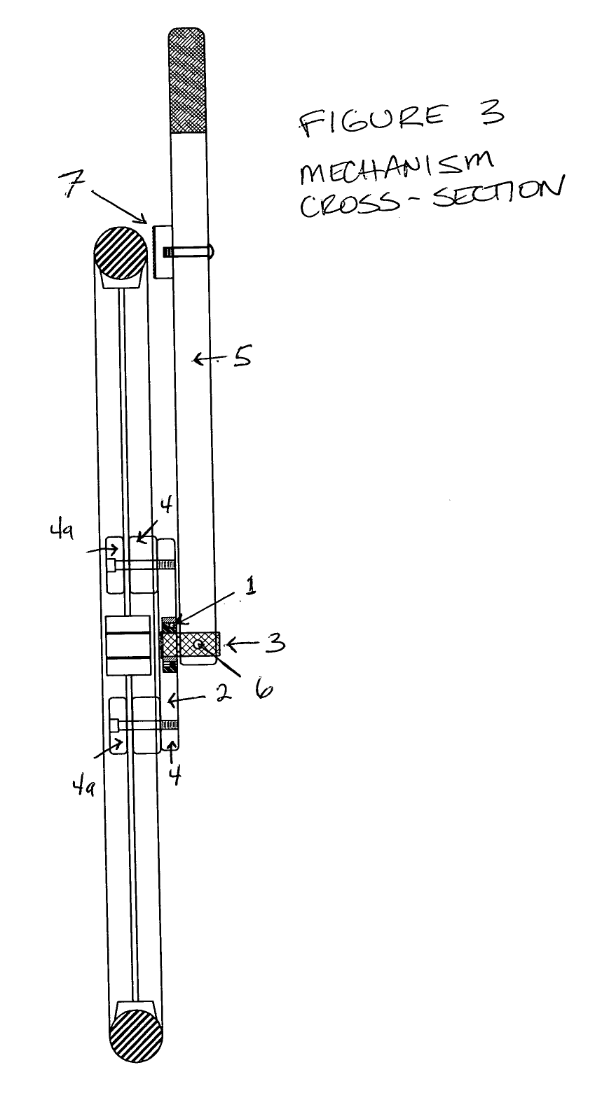

This system attaches to the primary drive wheel, or, in another embodiment, is incorporated within the primary drive wheel of a wheelchair to facilitate manual wheelchair operation. Using a lever attached to a one-way clutch bearing, wherein the center of the bearing is co-axial with the wheelchair axle, the wheelchair is driven by pushing said lever forward.

In this embodiment, a one-way bearing is mounted in a housing attached to the spokes of the main wheelchair drive wheel, such that forward motion of said bearing is in the same direction as forward rotation of said drive wheel. Said housing is attached to the wheelchair wheel by drive lugs at either end of said housing, which clamp onto the spokes of said wheelchair wheel. Said housing also contains a drive axle which extends through the center of the bearing, and an attachment means at the end of the drive axle for the purpose of attaching a lever. In other embodiments, the bearing housing is integrated into the hub of the wheel, and separate drive lugs are unnecessary.

The drive lugs in this embodiment are shaped such that they clamp onto the spokes of the wheel, thereby locating the geometric center of the bearing coaxially with the free-rotating axle of the wheelchair wheel. The bearing housing is mounted such that forward pressure on the lever attached to the axle located through the center of the bearing rotates the drive lugs forward, pressing on the spokes and thereby propelling the chair. Rearward pressure on the lever encounters no resistance. Therefore, the lever can be easily returned to the point at which forward pressure can then be resumed to drive the chair forward. In the preferred embodiment, one of these mechanisms is mounted on each drive wheel of a wheelchair.

### CROSS REFERENCE TO RELATED APPLICATIONS

There are many systems for driving wheelchairs, which include various mechanisms with gears and sprockets, a plurality of wheels, drive linkages and cables, motors, and many other methods.

In U.S. Pat. No. 4,523,769, Glaser uses a lever/ratchet mechanism to drive gears for propulsion. Taylor (U.S. Pat. No. 6,234,504) uses levers to drive sprockets, connected to the drive wheel via chains, similar to Banzi (U.S. Pat. No. 6,325,398). In U.S. Pat. No. 6,634,663, Mitchell uses a lever to operate a crank handle that presses on circular handrails attached to many wheelchair wheels when pressure is applied. U.S. Pat. No. 6,325,398 uses a chain transmission. Drake (U.S. Pat. No. 5,941,947) uses one-way clutches, but requires the attachment of drive cables to power the chair, and attaches the drive lever to a pivot point on the wheelchair frame, moving the lever attachment point away from the center of gravity of the chair, and requires a drive cable to convert lever motion to rotational motion. U.S. Pat. No. 3,994,509 (Sheaffer) cites the use of overrunning clutches, but connects them to a chain to drive the wheel(s).

### BACKGROUND

### Field of Invention

This is a wheelchair drive system consisting of a one-way bearing clutch permanently mounted in a housing, a drive axle extending through, and coaxial with, the bearing clutch and drive wheel of the wheelchair, an attachment means to attach said bearing clutch coaxial with the hub of a wheelchair wheel such that the drive axle is coaxial with the axle of the wheelchair drive wheel, a drive lever that attaches to the drive axle, and a braking surface on the side of the drive handle proximal to the wheelchair drive wheel.

In general, manually powered wheelchairs require the user to grasp a circular hand grip that is attached to the wheelchair drive wheel. To move the chair, they apply pressure to this grip and rotate said grip in the desired direction of travel. Since the grip is concentric with the wheel, and rotates as the wheel rotates, the user can apply maximum force to the rotating grip for only a portion of the rotation of the wheel. The grip then rotates out of the reach of the user, and the user needs to let go of the circular grip and grab it again at another point on the circumference of said grip, and reapply power to keep moving. In the preferred embodiment of this invention, one of these drive systems is mounted to each side of the wheelchair, such that there is a drive lever on each wheelchair drive wheel.

The drive lever, with the bearing clutch coaxial with the wheel axle, allows the user to push against a handle, maintaining a continuous grip. Since the lever is mounted such that the drive axle is coaxial with the wheelchair wheel axle, rotational force is applied directly to said wheelchair wheel.

The one-way operation of the bearing clutch allows for fractional rotational movements of the wheelchair wheel to be easily made with either hand for directional control. The frictional braking surface on the side of the handle lever facing the wheelchair wheel is actuated by pressing the lever against said wheel, thereby slowing the chair if both sides are used in braking, or for controlled turning while the chair is in motion. The user never has to let go of the handle to drive, brake, or turn the chair.

### OPERATION

In this embodiment, the bearing housing of said mechanism attaches to a wheelchair wheel by an attachment means that captivates said wheelchair wheel spokes between fasteners internal to the drive lugs on the inside of said spokes, and mounting locations for said drive lugs on the inner surface of the bearing housing. A drive axle extends from the inner surface of said bearing housing through the one-way bearing mounted in said housing. This drive axle extension provides a location on the drive axle such that a drive handle lever can be attached to said drive axle.

The inside surface of the drive handle has a frictional braking surface attached such that when the handle is flexed towards the wheelchair drive wheel on which the drive lever mechanism is mounted, said braking surface contacts the side of the wheelchair drive wheel and provides frictional contact for braking.

### INVENTION SUMMARY

Wheelchairs are often used by people who have physical impairments that diminish the strength available for propelling their chair. The mechanical advantage provided by the lever, the power transmission available by mounting a drive axle coaxial with the hub of the existing wheel, and the use of the one way bearing clutch to provide a simple mechanism for returning the lever to its drive position allows wheelchair users to propel a wheelchair using the large muscles in their upper bodies, while maintaining a continuous grip on the handle for control and braking.

This is a direct drive system, using no gears, cables, sprockets or transmissions to apply power to the wheels. It is a mechanism that attaches to wheelchair spokes, so users don't need to purchase an entirely new chair to get the benefits of such a lever-drive mechanism. In various embodiments of this design, different attachment means are used to attach the drive system to various spoke designs, or the bearing is mounted internal to the hub of the drive wheel.

### DETAILED DESCRIPTION OF DRAWING

One-way bearing 1 is permanently mounted in housing 2. Drive axle 3 is pressed through the open center of the one way bearing in housing 2. Housing 1 is attached to the wheelchair drive wheel spokes by means of drive lugs 4/4a, such that said wheelchair wheel spokes are captivated between drive lugs 4/4a and housing 1. Drive handle 5 is rigidly attached to drive axle 3 with an attachment means 6. In some embodiments, a frictional braking surface, 7, is attached along the length of drive handle 5 such that it can be pressed against the outer surface of the wheelchair wheel when drive handle 5 is flexed towards said wheelchair wheel.

What is claimed is:

1. A manual wheelchair drive attachment, comprising:
a one-way bearing which is attached to a wheelchair wheel such that the center of said one-way bearing is coaxial with the wheelchair wheel axle, a drive axle mounted through the center of said one-way bearing, a drive handle secured to said drive axle with an attachment means, and a frictional braking surface mounted on the inside of said handle such that flexing the handle toward the user of said wheelchair puts the braking surface in contact with the wheelchair wheel.
